(19) United States
(12) Patent Application Publication
(10) Pub. No.: US 2017/0226991 A1
(43) Pub. Date: Aug. 10, 2017

(54) MECHANICAL APPARATUS

(71) Applicant: William Hardy, Billericay, Essex (GB)

(72) Inventor: William Hardy, Billericay, Essex (GB)

(21) Appl. No.: 15/501,956

(22) PCT Filed: Jul. 31, 2015
(86) PCT No.: PCT/GB2015/052219

§ 371 Date: Feb. 6, 2017

(30) Foreign Application Priority Data
Aug. 5, 2014 (GB) 1413875.4
Oct. 10, 2014 (GB) 1417992.3
Nov. 10, 2014 (GB) 1419973.1

(51) Int. Cl. F03G 3/06

(52) U.S. Cl. CPC F03G 3/06; F03G 7/10

(57) ABSTRACT

The invention provides a mechanical apparatus comprising: a main wheel rotatable about a main axis; four radially spaced pendulum axes parallel to and around the main axis, and four pairs of weighted pendulums. Each pair is mounted to the main wheel for 360° rotation about a separate pendulum axis. A latching mechanism associated with each pendulum pair releasably but independently holds one or both pendulum of a pair at one or more rotational position, the engagement and/or release of a pendulum by a latching mechanism being operated by the movement of pendulums within the same or other pairs and/or by the rotation of the main wheel. As the main wheel rotates about the main axis the pendulums rotate about the pendulum axes under the control of the latching mechanism.

The present invention relates to mechanical apparatus. In particular it relates to mechanical apparatus that uses the movement of pendulums to encourage the rotation of a main wheel by overbalancing relative to the rotational axis of that main wheel.

According to the present invention there is provided mechanical apparatus comprising:
a main wheel rotatable about a main axis;
four pendulum axes parallel to and arranged around the main axis, the pendulum axes being radial spaced from the main axis;
four pairs of weighted pendulums, each pair mounted to the main wheel for 360° rotation about a separate pendulum axis, wherein each pendulum of a pair is independently rotatable about the same pendulum axis;
latching mechanisms associated with each pendulum pair to releasably independently hold one or both pendulum of a pair at one or more rotational position, the engagement and/or release of a pendulum by a latching mechanism being operated by the movement of pendulums within the same or other pairs and/or by the rotation of the main wheel;
whereby as the main wheel rotates about the main axis the pendulums rotate about the pendulum axes under the control of the latching mechanism.

The pendulums may be all the same or a combination of different lengths and weighs as long as these are appropriately balanced relative to the main axis. A pendulum may take the form of parts that are eccentrically weighted relative to the pendulum axis about which they rotate. Preferably all the pendulums are the same or broadly the same.

Four pairs works well, but more than four pairs of pendulums may be mounted for rotation on the main wheel. An increase in the number of pairs of pendulums would need an alteration in the timing of when those pendulums are held and released by the latching mechanism. The main axis and pendulum axes may ideally be arranged generally horizontally.

The pendulum axes are normally defined by rotational fixing points for the pendulums and these are radially spaced from the main axis to ensure a turning moment can be imparted to the main wheel. The degree of radial spacing can vary, but needs to be enough such that the pendulums can rotate without impeding each other or crossing the main axis.

Four pairs of pendulums may be spaced approximately 90° around the main wheel. If more than four are employed the spacing would need to be adjusted accordingly.

The latching mechanism may be configured selectively to hold some or all of the pendulums at various rotational points. These may include a first position whereat a pendulum (and/or its centre of mass) is at or adjacent the point on its rotational path that is between adjacent rotational fixing points (which are coincident with the pendulum axes). Ideally the first position is generally on a notional straight line between the rotational fixing point for an associated pendulum and the rotational fixing point for pendulum next in a forward rotational position. The various rotational points may instead or as well include a second position which is generally between adjacent rotational fixing points but not the same pair of rotational fixing points as the first position. Ideally the second position is on a notional straight line between the rotational fixing point for an associated pendulum and the rotational fixing point for pendulum next in a rearward rotational position. The points may be directly between the rotational fixing points or may be spaced nearer to (or more preferably for the second position further from) the centre of the wheel.

The internal angle between a pair of pendulums held at the first and second positions is ideally less than 180°, and is preferably approximately 135° or 90°.

The latching mechanism may be configured such that when engaged with a pendulum, that pendulum may be prevented from rotation in either just one direction or in both directions. If held against rotation in just one direction, rotation of the main wheel may move the pendulum to a position at which gravity will cause rotation of the pendulum in the opposition direction. Operation of certain parts of the latching mechanism can be controlled by pendulums engaging or striking parts that act as actuators and which operate to change the latching status of other pendulums to either catch or release those. The latching mechanism may also in part be actuated by the differing direction of gravitational force as the main wheel rotates.

The latching mechanism may be configured such that the movement of different pendulums within a pair may have equivalent or different effects. For example one being held at the first position may cause release of another part of the latching mechanism—whereas the other being held at the first position may not. This is useful in timing the movement and release of the pendulums.

The main wheel must rotate about the main axis and provide a mount for the pendulums. The latching mechanisms for each pendulum may also at least in part act between the main wheel and the respective pendulum to hold it relative thereto. The main wheel may be generally circular but may also take any shape that permits appropriate mounting of the pendulums. A generally octagonal shape has been found convenient.

In order to permit the independent rotation of each pendulum of a pair, the pendulums are axially spaced or separated along a pendulum axis by an amount sufficient to prevent them interfering with each other.

Operation of a latching mechanism may be achieved by coupling to the movement of one pendulum. This might take the form of a latch that is operated by a pendulum coming into contact with an actuator as the pendulum rotates. For example the engagement of one pendulum with a latching mechanism adjacent the first position on a wheel may cause the release of another pendulum at a different part of the main wheel so that that pendulum may rotate.

Another mechanism might be a face cam behind the main wheel and a series of pegs that are operable by that face cam to extend variably from the main wheel to block or unblock the path of the pendulums.

So that the invention may be better understood, an embodiment will now be described in detail, but by way of example only, with reference to the following drawings in which:

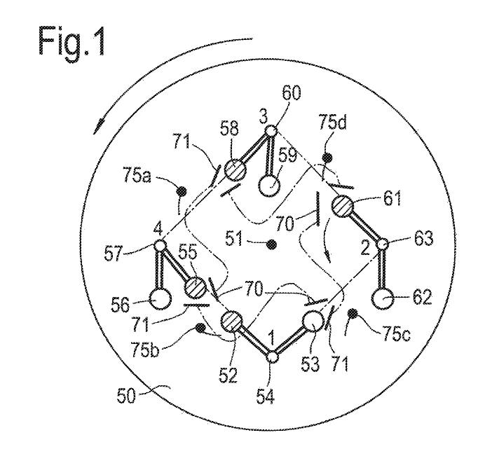

FIGS. 1 show a mechanism of the present invention showing the pendulums on the main wheel which rotates in the direction of the arrow;

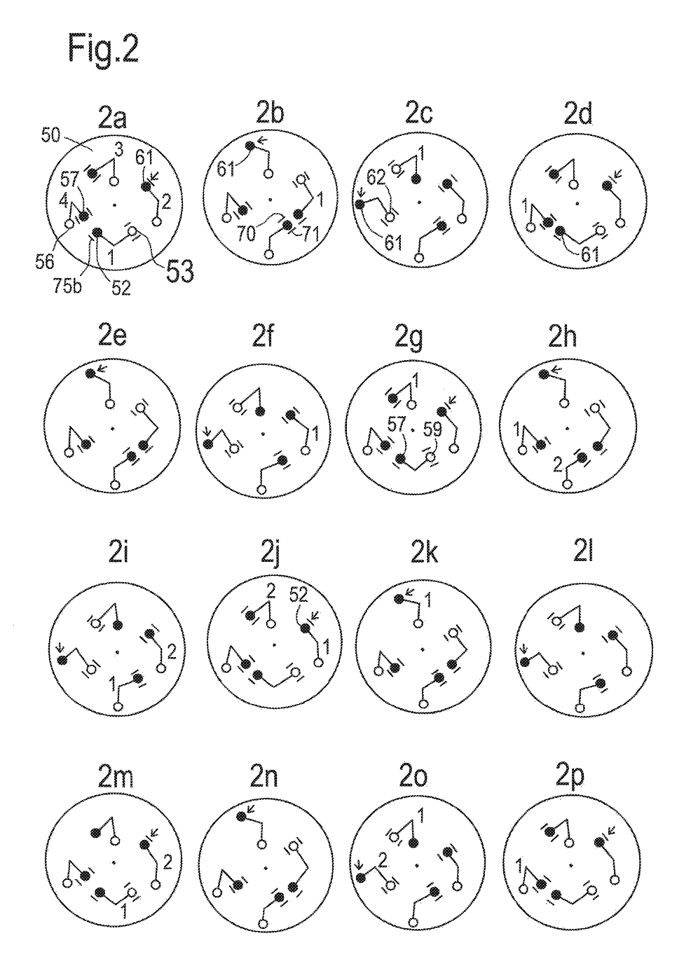

FIG. 2 shows a series of simplified images of the same mechanism in a sequence in 16 quarter turns (images 2a to 2p) of 4 rotations of the main wheel;

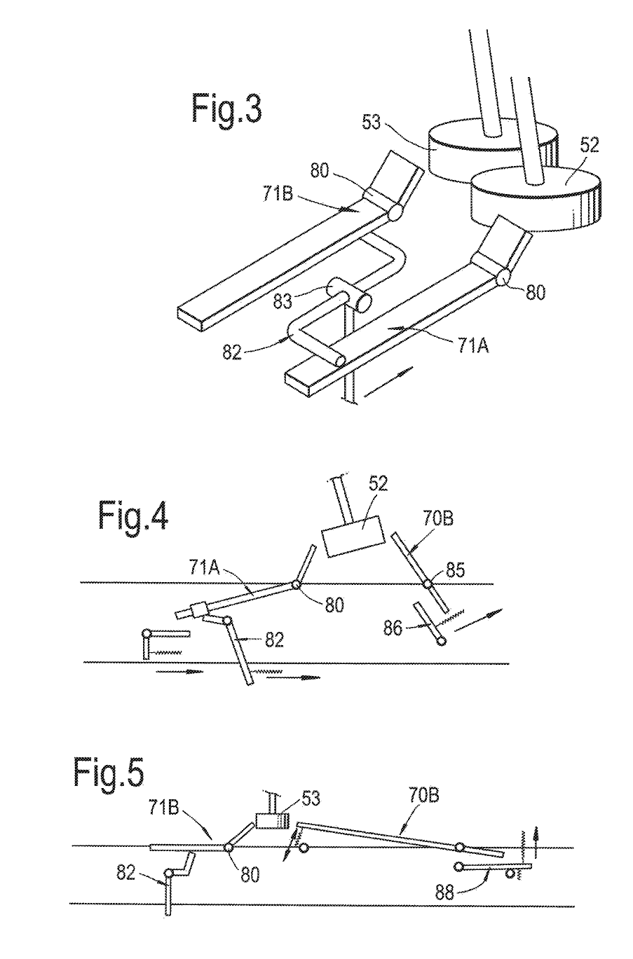

FIG. 3 shows a simplified representation of a part of an embodiment of latching mechanism;

FIG. 4 shows a part of the latching mechanism engaged with an outer pendulum; and

FIG. 5 shows a part of the latching mechanism engaged with an inner pendulum.

FIG. 1 shows an embodiment of the present invention in a first position. The apparatus comprises a main wheel 50, mounted for rotation about a main axle 51 that is generally horizontal. There are eight pendulums on the main wheel in four pairs, with pendulums 52 and 53 rotatably mounted on a first pendulum axis 54; 55 and 56 rotatably mounted on a fourth pendulum axis 57; 58 and 59 rotatably mounted on a third pendulum axis 60; and 61 and 62 rotatably mounted on a second pendulum axis 63.

The inner pendulums 53, 56, 59 and 62 (i.e. those closest to the main wheel in this view) are shown in white and may be fixed in position by movable pegs 70 and latches 71 at a first position on its rotational path that is between adjacent pendulum axes. These pegs 70 and latches 71 form part of the latching mechanism. The pegs 70 block anti-clockwise rotation of the pendulums and the latches prevent clockwise rotation of the pendulums. Pins 75a, 75b, 75c and 75d are on an opposite side of the associated pendulum axis and these can move between positions where they hold the outer pendulums (i.e. those furthest from the main wheel in this view and shown hatched to distinguish from the inner ones) such as 75b in FIG. 1 and positions where those pendulums may freely rotate (such as 75c in FIG. 1). The pins do not interfere with the movement of the inner pendulums.

FIGS. 2a to 2p show a series of images at quarter turns as the main wheel rotates 4 times. These images are as the wheel is in a steady state of rotation. FIG. 2a is the same position as shown in FIG. 1. Motion of the pendulums may differ slightly during a change from a stationary wheel to a moving one. In FIG. 2 the black pendulums are the outer pendulums and the white ones are the inner pendulums. So that they are easy to track, the pairs of pendulums are shown at positions 1-4 numbered in an anticlockwise direction.

The wheel rotates anticlockwise in sequence as shown in FIG. 2. Starting the wheel from a standing start it is moved anticlockwise. It is of course possible that the wheel may be configured to rotate clockwise.

In FIG. 2a the outer pendulum at position 1 (ie pendulum 52) is held in place by pin 75a so that the balance of the wheel is off centre and rotation in an anticlockwise orientation in encouraged. The pins 75a-75d do not limit movement of the inner (white) pendulums. Meanwhile its pair, inner pendulum 53 is pressing on latch 71. This is coupled by a mechanism (not visible, but represented by a dotted line in FIG. 1) to peg 70 of the pendulums at position 2 in such a way that peg 70 is moved so that it no longer prevents anticlockwise rotation of pendulum 61. Initially pendulum 61 may be held by gravity against latch 71, but as position 2 approaches the position as shown in FIG. 2a (“3 pm” on the main wheel) that no longer applies and pendulum 61 may spin back anticlockwise. The pendulum 61 falls and whips up the other side with significant momentum, it swings up and goes into a spin around its axis. The remaining pendulums are balancing the wheel. In FIG. 2b, position 2 and pendulum 61 are at the top of the wheel. As the wheel continues to rotate toward that shown in FIG. 2c this pendulum now engages a pin 75c so that as can be seen in 2d it is held at the second position between the 63 and the axis 54 by gravity.

Similar to that shown in 2a, and by the equivalent mechanism, pendulum 62 in turn causes the release of peg 70 at position 3 so that pendulum 58 can swing anticlockwise as did pendulum 61 before it. This again passes the top (after FIG. 2e) and is caught by pin 75d. In FIG. 2g pendulum 58 presses on pin 75d and pendulum 59 causes release of the peg holding pendulum 55 at position 4.

In turn the pendulums at position 4 will cause the release of pendulum 52 (FIG. 2j) which will spin (FIG. 2k), engage the pin at between 9 o'clock (FIG. 2l) and start the sequence again at FIG. 2m. FIGS. 2m to 2p are equivalent to 2a to 2d. Three rotations of the wheel involves the drop and spin of four pendulums.

Before FIG. 2a the outer pendulum 55 is moving and the inner 56 is fixed. In FIG. 2a the outer pendulum 55 passes the inner one 56 and in the process becomes held in place yet releases the inner 56 to hang down freely. By this mechanism they swap places. The same happens with other pairs of inner and outer pendulums in FIGS. 2d, 2g and 2j. When an inner pendulum is held at a first position (which in this embodiment is between one pendulum axis and the next in a forward rotational direction) after it approaches 6 o'clock this releases the adjacent peg 70 (as in FIG. 2a), however when an outer pendulum is held at the inner position as it passes the same point it does not actuate release of the adjacent peg 70 (for example as shown at FIG. 2b).

FIGS. 3 to 5 show in more detail various parts of an embodiment of latching mechanism that holds and releases pendulums. FIG. 3 shows the movable latches 71 at a first position (although all latching mechanisms at the various positions are equivalent) on the rotational path. The inner latch 71B holds an inner pendulum 53 and the outer latch 71A holds an outer pendulum 52. As can be seen each latch is a lever that pivots about a pivot point 80 which may or may not be coaxial with other pivot points 80. A trigger mechanism 82 is arranged to rotate about a trigger pivot 83, under external activation, to cause opposite movement of the inner and outer latches.

FIGS. 4 and 5 show vertical sections through the inner and outer latches and further show outer and inner pegs 70A and 70B that are on the opposite sides of the pendulums to limit movement in an opposed direction. The outer peg 70A (FIG. 4) pivots about peg pivot 85 and is controlled by an outer actuator assembly 86 that is linked to the latch mechanism of a different pendulum pair. Likewise the inner peg 70B pivots about an inner peg pivot 87 and is controlled by an inner actuator assembly 88 that is differently linked to the latch mechanism of another pendulum pair.

By the sequential mechanism of holding, swapping and release of the pendulums of the pairs, the motion of the main wheel continues.

1. Mechanical apparatus comprising:
a main wheel rotatable about a main axis;
four pendulum axes parallel to and arranged around the main axis, the pendulum axes being radial spaced from the main axis;
four pairs of weighted pendulums, each pair mounted to the main wheel for 360° rotation about a separate pendulum axis, wherein each pendulum of a pair is independently rotatable about the same pendulum axis;
latching mechanisms associated with each pendulum pair releasably but independently to hold one or both pendulum of a pair at one or more rotational position, the engagement and/or release of a pendulum by a latching mechanism being operated by the movement of pendulums within the same or other pairs and/or by the rotation of the main wheel;
whereby as the main wheel rotates about the main axis the pendulums rotate about the pendulum axes under the control of the latching mechanism.

2. Mechanical apparatus as claimed in claim 1, wherein the latching mechanism can hold one pendulum of each pair at 2 positions, and the other pendulum of each pair at one position.

3. Mechanical apparatus as claimed in claim 2, wherein each pendulum may be selectively held at a first position on its rotational path that is between adjacent pendulum axes, and one pendulum is also selectively held at a different second position that is also on its rotational path between adjacent pendulum axes.

4. Mechanical apparatus as claimed in claim 3, wherein the first position is generally on a notional straight line between the pendulum axis for an associated pendulum and the pendulum axis for a pendulum next in a forward rotational position.

5. Mechanical apparatus as claimed in claim 3, wherein the second position is on its rotational path that is between adjacent pendulum axes.

6. Mechanical apparatus as claimed in claim 5, wherein the second position is generally on a notional straight line between the pendulum axis for an associated pendulum and the pendulum axis for a pendulum next in a rearward rotational position.

7. Mechanical apparatus as claimed in claim 4, wherein the second position is on its rotational path that is between adjacent pendulum axes.
